(19) United States
(12) Patent Application Publication
(10) Pub. No.: US 2026/0045778 A1
(43) Pub. Date: Feb. 12, 2026

(54) Sealed Enclosure Apparatus

(71) Applicant: Karl Wolf, Round Rock, TX (US)

(72) Inventor: Karl Wolf, Round Rock, TX (US)

(21) Appl. No.: 18/795,970

(22) Filed: Aug. 6, 2024

(51) Int. Cl. H02G 15/013; F16J 15/10; G02B 6/44

(52) U.S. Cl. CPC H02G 15/013; F16J 15/104; G02B 6/44465

(57) ABSTRACT

The sealed enclosure apparatus is a seal between an entering or exiting cable or wire and an enclosure. The seal has an upper gasket and bottom gasket that are typically U, C, or V shaped. The seal is held in-place and constrained by features on the upper housing and features on the bottom housing. The seal and the housing enclosure provide strain relief and superior sealing. The seal technique described can be used in other hardware to provide an environmental seal to tubes, rods, fiber cables, electrical cables and other such objects. The sealed enclosure apparatus has a bottom housing, an upper housing, a gasket interference, and wires.

### FIELD OF THE INVENTION

The present invention relates generally to a sealed enclosure. More specifically the present invention utilizes gaskets within a sealed enclosure to create a water-tight seal around cables or wires.

### BACKGROUND OF THE INVENTION

Sealed enclosures are a protection device that are used outdoors above or below ground. Sealed enclosures provide environmental protection (water, dust, salt, etc.) for interconnections of fiber optic cable, electrical cable, and similar devices. Cut or uncut cables are commonly fed through the gasket openings in the enclosure. The amount of cable needed for the installation is many times not known until the cable is being installed in the field. Commonly the gasket used is a simple butt-joint to seal around a cable and sealed to the enclosure. However, this butt-joint seal can be problematic if the cable is moved, and the strain relief cannot prevent small movements of the gasket at the butt-joint interface.

### BRIEF DESCRIPTION OF THE DRAWINGS

FIG. 1 is an exploded top front left perspective view of the present invention.

FIG. 2 is an exploded bottom front left perspective view of the present invention.

FIG. 3 is a top front left perspective view of the present invention without the upper housing.

FIG. 4 is a top front left perspective view of the present invention.

FIG. 5 is a top view of the present invention.

FIG. 6 is an alternative embodiment of the present invention.

FIG. 7 is an alternative embodiment of the present invention.

FIG. 8 is an illustration depicting the gasket interference of the present invention.

### DETAIL DESCRIPTIONS OF THE INVENTION

All illustrations of the drawings are for the purpose of describing selected versions of the present invention and are not intended to limit the scope of the present invention.

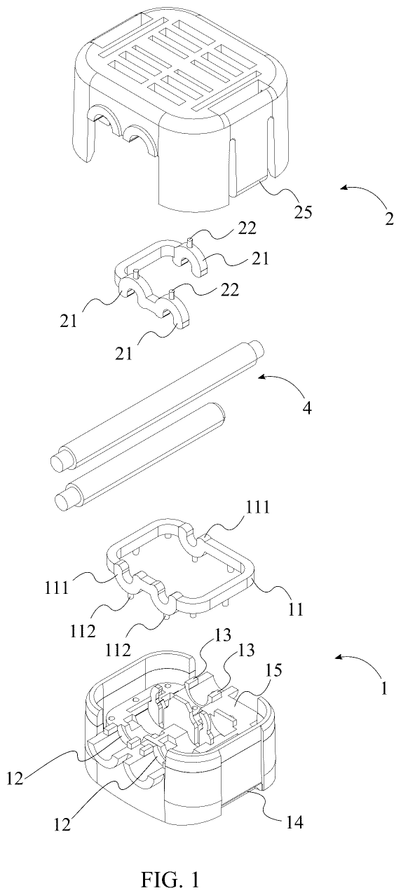

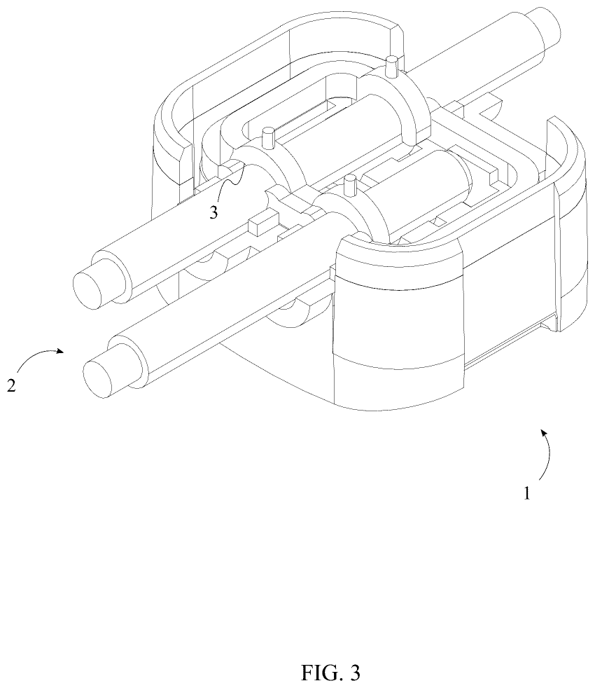

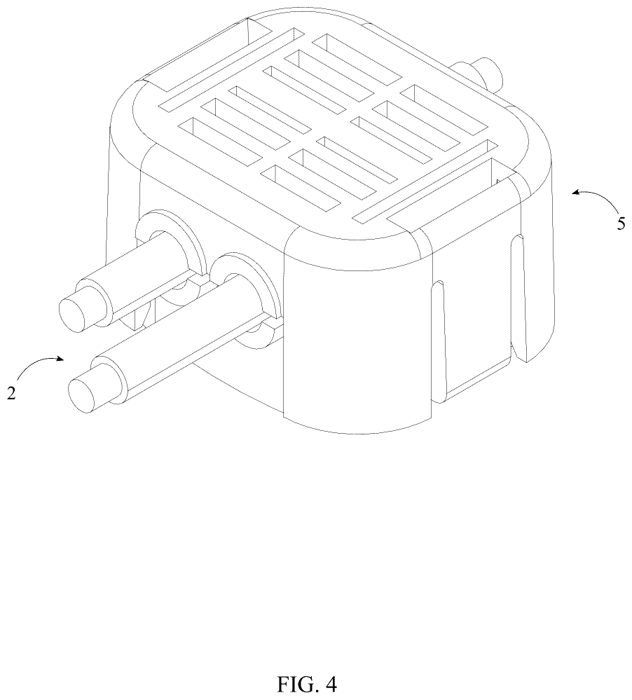

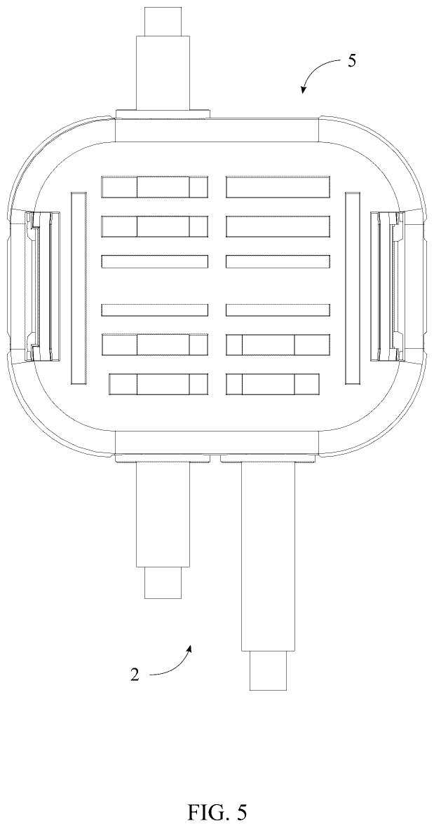

The present invention, as shown in FIG. 1-8, is a seal between an entering or exiting cable or wire and an enclosure. The seal comprises of an upper housing 2 and bottom housing 1 that are typically U, C, or V shaped. The seal is held in-place and constrained by features on the upper housing 2 and features on the bottom housing 1. The seal and the housing enclosure 5 provide strain relief and superior sealing. The seal technique described can be used in other hardware to provide an environmental seal to tubes, rods, fiber cables, electrical cables and other such objects. It allows for easy reentry into the enclosure which is required in many outdoor applications.

In reference to FIG. 1, the sealed enclosure apparatus comprises a bottom housing 1, an upper housing 2, a gasket interference 3, and a plurality of wires 4. The bottom housing 1 comprises a bottom gasket 11, a plurality of bottom gasket receivers 12, a plurality of bottom gasket restraints 13, and a plurality of housing clasp receivers 14. The bottom gasket 11 comprises a plurality of wire receivers 111 and a plurality of bottom gasket fasteners 112. The upper housing 2 comprises a plurality of upper gaskets 21, a plurality of upper gasket fasteners 22, a plurality of upper gasket receivers 23, a plurality of upper gasket restraints 24, and a plurality of housing clasps 25. The gasket interference 3 is an area where the bottom gasket 11 and the plurality of upper gaskets 21 touch one another. These are designed to have an interference fit in the axial direction such that when compressed radially they will press against one another to form a seal in the axial direction. The bottom gasket 11 and each of the plurality of upper gaskets 21 are designed elastomeric materials with a shore hardness between 20 to 70. However, some situations will require a hardness outside of this range. In an alternative embodiment each of the plurality of gasket fasteners 22 utilize a gasket material that bonds with the housing enclosure 5 when over molded. The bottom housing 1 receives the upper housing 2. As a result, the bottom housing 1 interlocks with the upper housing 2. The bottom housing 1 and upper housing 2 forms a housing enclosure 5. The housing enclosure 5 receives a plurality of wires 4. Consequently, the housing enclosure 5 is designed to receive numerous wires and constrain each in an axial and radial direction. The housing enclosure 5 forms a watertight seal around the plurality of wires 4. The housing enclosure 5 is made of a stiff material that is able to support the bottom gasket 11 and the plurality of upper gaskets 21 properly when compressed.

The housing enclosure 5 is a stiff enclosure that can designed with anything from materials like metals to rigid plastics like, filled polypropylene, polycarbonate or filled polycarbonate, nylon or filled nylon, etc.

Further, the bottom gasket 11 traverses around a bottom housing inner surface 15 as seen in FIG. 1. Accordingly, the bottom gasket 11 is sealed between the bottom housing 1 and the upper housing 2. The bottom gasket 11 is a flexible and non-porous material. Thus, the bottom gasket 11 prevents water and other unwanted debris from entering the housing enclosure 5. Each of the plurality of wire receivers 111 is a semi-circular bends along the bottom gasket 11. So, each of the plurality of wire receivers 111 is designed to receive each of the plurality of wires 4 or cables securing each within the housing enclosure 5. During assembly of the housing enclosure 5 the bottom gasket 11 is compressed to create a seal between the bottom housing 1 and the upper housing 2. Further, during the assembly of the housing enclosure 5 the plurality of wire receivers 111 and plurality of upper gaskets 21 are compressed to create a seal around the plurality of wires 4.

Furthermore, the plurality of bottom gasket receivers 12 secures the bottom gasket 11 within the bottom housing 1. The plurality of bottom gasket restraints 13 prevents axial movement from the bottom gasket 11. As a result, the bottom gasket 11 is constrained in the axial and radial directions by both the plurality of bottom gasket receivers 12 and the plurality of bottom gasket restraints 13. Consequently, the plurality of bottom gasket fasteners 112 mechanically hold the bottom gasket 11 within the bottom housing 1 shown in FIG. 1. In an alternative embodiment the bottom gasket fastener 112 utilizes a gasket material that bonds with the housing enclosure 5 when over molded.

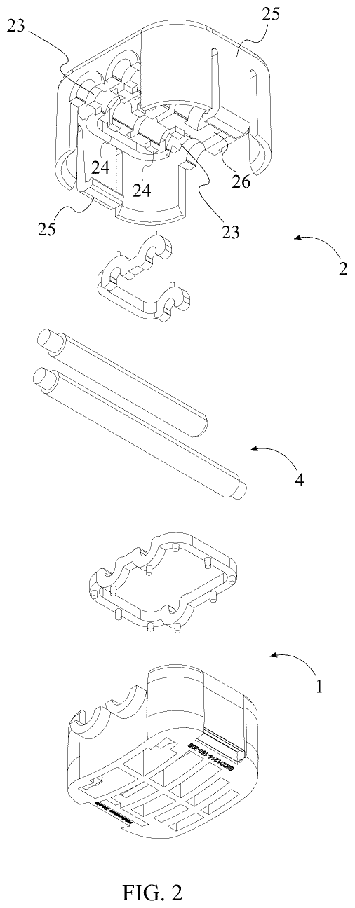

In reference to FIG. 2, the plurality of housing clasp receivers 14 integrates into the bottom housing 1. The plurality of housing clasps 25 integrates into the upper housing 2. The plurality of housing clasp receivers 14 and the plurality of housing clasps 25 locks the bottom housing 1 to the upper housing 2. Accordingly, the upper housing 2 and bottom housing 1 are locked together to form the housing enclosure 5. This applies pressure to the bottom gasket 11 and plurality of upper gaskets 21 sandwiched between the upper housing 2 and bottom housing 1. The bottom gasket 11 forms a watertight seal between the bottom housing inner surface 15 and a upper housing 2 inner surface. Thus, the bottom gasket 11 prevents water and unwanted debris from entering the housing enclosure 5 at locations that do not touch the plurality of wires 4.

In reference to FIG. 1, each of the plurality of upper gaskets 21 is a semi-circular member. In an alternative embodiment each of the plurality of upper gaskets 21 utilize a U or V shape that receive each of the plurality of wires 4 or cables. Each of the plurality of upper gasket receivers 23 secures each of the plurality of upper gaskets 21 within the upper housing 2. The plurality of upper gasket restraints 24 prevents axial movement from each of the plurality of upper gaskets 21. So, plurality of upper gaskets 21 is constrained in the axial and radial directions by both the plurality of upper gasket receivers 23 and the plurality of upper gasket restraints 24.

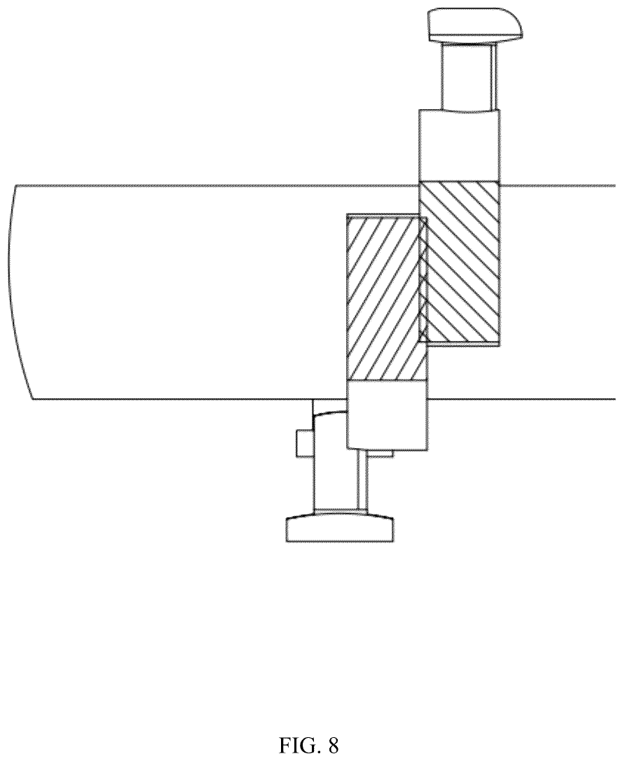

Further, each of the plurality of upper gaskets 21 and each of the plurality of wire receivers 111 engages to form the gasket interference 3. As a result, the gasket interference 3 is a seal between each of the plurality of upper gaskets 21 and each of the plurality of wire receivers 111. Each of the plurality of upper gaskets 21 and each of the plurality of wire receivers 111 encircles the radial surface of each of the plurality of wires 4. Consequently, the plurality of upper gaskets 21 and the plurality of wire receivers 111 completes a seal around the plurality of wires 4 with the housing enclosure 5. Furthermore, the gasket interference 3 forms a water-tight seal around each of the plurality of wires 4. The inner diameter of each of the plurality of upper gaskets 21 and each of the plurality of wire receivers 111 is smaller than the outer diameter of each of the plurality of wires 4 to form a proper seal wherein each of the plurality of upper gaskets 21 overlaps each of the plurality of wire receivers 111 as shown in FIG. 8.

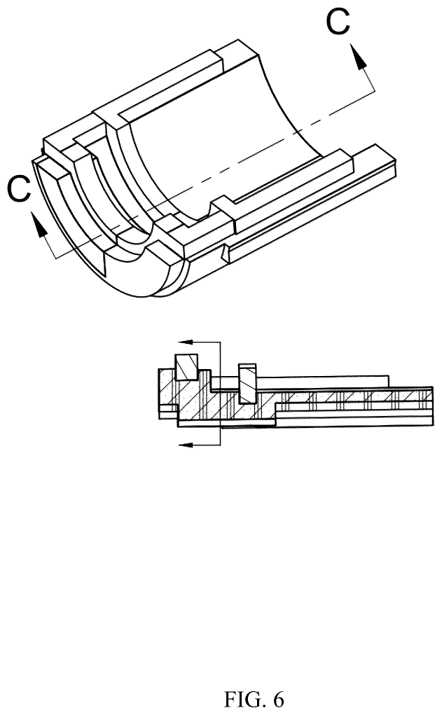

In an alternative embodiment, each of the plurality of bottom gasket receivers 12 integrates along the bottom housing 1 with varying heights. Each of the plurality of upper gasket receivers 23 integrates along the upper housing 2 with varying heights. Each of the plurality of wire receivers 111 and each of the plurality of upper gaskets 21 seals around each of the plurality of wires 4 with varying diameters. As shown in FIG. 6, a stepped enclosure is utilized to accommodate different diameters for each of the plurality of wires 4. This results in each of the plurality of upper gaskets 21 and each of the plurality of wire receivers 111 being linearly placed along the stepped enclosure. This design creates a small, sealed opening and a large, sealed opening between each of the plurality of upper gaskets 21 and each of the plurality of wire receivers 111. When the small, sealed opening is sealed around a wire the large, sealed opening stays in position. However, when the large, sealed opening is sealed around a wire with a larger diameter the material forming the small, sealed opening is removed.

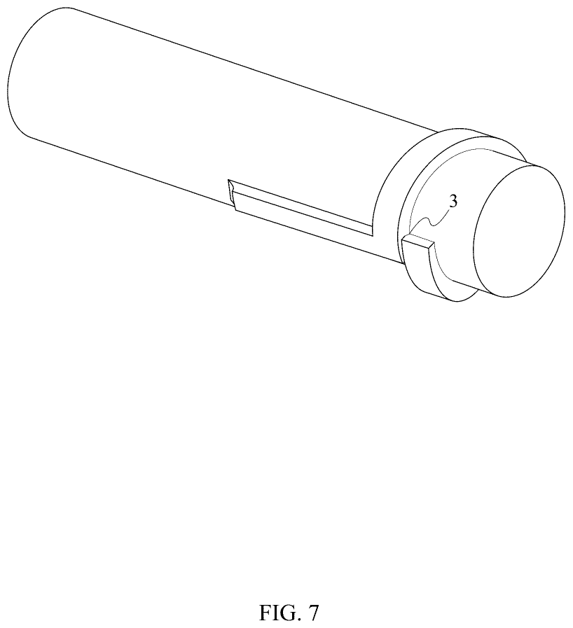

In another alternative embodiment as seen in FIG. 7, each of the plurality of upper gaskets 21 forms a spiral shape. A plurality of bottom gaskets 11 each forms a spiral shape. Each of the plurality of upper gaskets 21 interlocks with each of the plurality of bottom gaskets 11.

Each of the plurality of upper gaskets 21 and each of the plurality of bottom gaskets 11 overlap in a crisscross fashion and generate a gasket seal. In this embodiment the plurality of upper gaskets 21 is identical to each of the plurality of bottom gaskets 11 wherein one of the two is rotated 180° from the other. This reduces the manufacturing costs because one manufacturing device can create the gaskets needed. The outer surface of each of the plurality of upper gaskets 21 and each of the plurality of bottom gaskets 11 would be bonded or held in place against a rigid plastic molded enclosure. The inner surface of the plurality of bottom gaskets 11 and the plurality of upper gaskets 21 would seal against the wire or cable. This allows for each of the plurality of upper gaskets 21 and each of the plurality of bottom gaskets 11 to interfere and create a seal. The gasket interference 3 is formed during the enclosure assembly and with the use of gasket constrains which is the plurality of bottom gasket restraints 13 and the plurality of upper gasket restraints 24.

Although the invention has been explained in relation to its preferred embodiment, it is to be understood that many other possible modifications and variations can be made without departing from the spirit and scope of the invention as hereinafter claimed.

What is claimed is:

1. A sealed enclosure apparatus comprising:
a bottom housing;
a top housing;
a gasket interference;
a plurality of wires;
the bottom housing comprising a bottom gasket, a plurality of bottom gasket receivers, a plurality of bottom gasket restraints, and a plurality of housing clasp receivers;
the bottom gasket comprising a plurality of wire receivers and a plurality of bottom gasket fasteners;
the upper housing comprising a plurality of upper gaskets, a plurality of upper gasket fasteners, a plurality of upper gasket receivers, a plurality of upper gasket restraints, and a plurality of housing clasps;
the bottom housing receiving the top housing;
the bottom housing and top housing forming a housing enclosure;
the housing enclosure receiving the plurality of wires; and
the housing enclosure forming a watertight seal around the plurality of wires.

2. The sealed enclosure apparatus as claimed in claim 1 comprising:
the bottom gasket traversing around a bottom housing inner surface;
the bottom gasket being a flexible and non-porous material; and
each of the plurality of wire receivers being a series of semi-circular bends along the bottom gasket.

3. The sealed enclosure apparatus as claimed in claim 2 comprising:
the plurality of bottom gasket receivers securing the bottom gasket within the bottom housing; and
the plurality of bottom gasket restraints preventing axial movement from the bottom gasket.

4. The sealed enclosure apparatus as claimed in claim 1 comprising:
the plurality of housing clasp receivers integrating into the bottom housing;
the plurality of housing clasps integrating into the upper housing;
the plurality of housing clasp receivers and the plurality of housing clasps locking the bottom housing to the upper housing; and
the bottom gasket forming a watertight seal between the bottom housing inner surface and a top housing inner surface.

5. The sealed enclosure apparatus as claimed in claim 1 comprising:
each of the plurality of upper gaskets being semi-circular members;
the plurality of upper gasket receivers securing each of the plurality of upper gaskets within the upper housing; and
the plurality of upper gasket restraints preventing axial movement from each of the plurality of upper gaskets.

6. The sealed enclosure apparatus as claimed in claim 5 comprising:
each of the plurality of upper gaskets and each of the plurality of wire receivers engaging to form the gasket interference; and
each of the plurality of upper gaskets and each of the plurality of wire receivers encircling the radial surface of each of the plurality of wires.

7. The sealed enclosure apparatus as claimed in claim 6 wherein the gasket interference forming a water-tight seal around each of the plurality of wires.

8. The sealed enclosure apparatus as claimed in claim 1 comprising:
each of the plurality of bottom gasket receivers integrating along the bottom housing with varying heights;
each of the plurality of upper gasket receivers integrating along the upper housing with varying heights; and
each of the plurality of wire receivers and each of the plurality of upper gaskets sealing around each of the plurality of wires with varying diameters.

9. The sealed enclosure apparatus as claimed in claim 1 comprising:
each of the plurality of upper gaskets forming a spiral shape;
a plurality of bottom gaskets each forming a spiral shape; and
each of the plurality of upper gaskets interlocking with each of the plurality of bottom gaskets.

10. The sealed enclosure apparatus as claimed in claim 1 comprising:
the bottom gasket bonding to the plurality of bottom gasket receivers; and
the plurality of upper gaskets bonding to the plurality of upper gasket receivers.

11. A sealed enclosure apparatus comprising:
a bottom housing;
a top housing;
a gasket interference;
a plurality of wires;
the bottom housing comprising a bottom gasket, a plurality of bottom gasket receivers, a plurality of bottom gasket restraints, and a plurality of housing clasp receivers;
the bottom gasket comprising a plurality of wire receivers and a plurality of bottom gasket fasteners;
the upper housing comprising a plurality of upper gaskets, a plurality of upper gasket fasteners, a plurality of upper gasket receivers, a plurality of upper gasket restraints, and a plurality of housing clasps;
the bottom housing receiving the top housing;
the bottom housing and top housing forming a housing enclosure;
the housing enclosure receiving a plurality of wires; and
the housing enclosure forming a watertight seal around the plurality of wires.

12. The sealed enclosure apparatus as claimed in claim 11 comprising:
the bottom gasket traversing around a bottom housing inner surface;
the bottom gasket being a flexible and non-porous material;
each of the plurality of wire receivers being a series of semi-circular bends along the bottom gasket;
the plurality of bottom gasket receivers securing the bottom gasket within the bottom housing; and
the plurality of bottom gasket restraints preventing axial movement from the bottom gasket.

13. The sealed enclosure apparatus as claimed in claim 11 comprising:
the plurality of housing clasp receivers integrating into the bottom housing;
the plurality of housing clasps integrating into the upper housing;
the plurality of housing clasp receivers and the plurality of housing clasps locking the bottom housing to the upper housing; and
the bottom gasket forming a watertight seal between the bottom housing inner surface and a top housing inner surface.

14. The sealed enclosure apparatus as claimed in claim 13 comprising:
each of the plurality of upper gaskets being semi-circular members;
the plurality of upper gasket receivers securing each of the plurality of upper gaskets within the upper housing;
the plurality of upper gasket restraints preventing axial movement from each of the plurality of upper gaskets;
each of the plurality of upper gaskets and each of the plurality of wire receivers engaging to form the gasket interference; and
the plurality of upper gaskets and the plurality of wire receivers encircling the radial surface of each of the plurality of wires.

15. The sealed enclosure apparatus as claimed in claim 14 wherein the gasket interference forming a water-tight seal around each of the plurality of wires.

16. The sealed enclosure apparatus as claimed in claim 11 comprising:
each of the plurality of bottom gasket receivers integrating along the bottom housing with varying heights;
the plurality of upper gasket receivers integrating along the upper housing with varying heights; and
each of the plurality of wire receivers and each of the plurality of upper gaskets sealing around each of the plurality of wires with varying diameters.

17. The sealed enclosure apparatus as claimed in claim 11 comprising:
each of the plurality of upper gaskets forming a spiral shape;
a plurality of bottom gaskets each forming a spiral shape;
each of the plurality of upper gaskets interlocking with each of the plurality of bottom gaskets;
the bottom gasket bonding to the plurality of bottom gasket receivers; and
the plurality of upper gaskets bonding to the plurality of upper gasket receivers.

18. A sealed enclosure apparatus comprising:
a bottom housing;
a top housing;
a gasket interference;
a plurality of wires;
the bottom housing comprising a bottom gasket, a plurality of bottom gasket receivers, a plurality of bottom gasket restraints, and a plurality of housing clasp receivers;
the bottom gasket comprising a plurality of wire receivers and a plurality of bottom gasket fasteners;
the upper housing comprising a plurality of upper gaskets, a plurality of upper gasket fasteners, a plurality of upper gasket receivers, a plurality of upper gasket restraints, and a plurality of housing clasps;
the bottom housing receiving the top housing;
the bottom housing and top housing forming a housing enclosure;
the housing enclosure receiving a plurality of wires; and
the housing enclosure forming a watertight seal around the plurality of wires.

19. The sealed enclosure apparatus as claimed in claim 18 comprising:
the bottom gasket traversing around a bottom housing inner surface;
the bottom gasket being a flexible and non-porous material;
each of the plurality of wire receivers being a series of semi-circular bends along the bottom gasket;
the plurality of bottom gasket receivers securing the bottom gasket within the bottom housing;
the plurality of bottom gasket restraints preventing axial movement from the bottom gasket;
the plurality of housing clasp receivers integrating into the bottom housing;
the plurality of housing clasps integrating into the upper housing;
the plurality of housing clasp receivers and the plurality of housing clasps locking the bottom housing to the upper housing; and
the bottom gasket forming a watertight seal between the bottom housing inner surface and a top housing inner surface.

20. The sealed enclosure apparatus as claimed in claim 18 comprising:
each of the plurality of upper gaskets being semi-circular members;
the plurality of upper gasket receivers securing each of the plurality of upper gaskets within the upper housing;
the plurality of upper gasket restraints preventing axial movement from each of the plurality of upper gaskets;
each of the plurality of upper gaskets and each of the plurality of wire receivers engaging to form the gasket interference;
each of the plurality of upper gaskets and each of the plurality of wire receivers encircling the radial surface of each of the plurality of wires;
the gasket interference forming a water-tight seal around each of the plurality of wires;
each of the plurality of bottom gasket receivers integrating along the bottom housing with varying heights;
each of the plurality of upper gasket receivers integrating along the upper housing with varying heights;
each of the plurality of wire receivers and each of the plurality of upper gaskets sealing around each of the plurality of wires with varying diameters;
each of the plurality of upper gaskets forming a spiral shape;
a plurality of bottom gaskets each forming a spiral shape;
each of the plurality of upper gaskets interlocking with each of the plurality of bottom gaskets;
the bottom gasket bonding to the plurality of bottom gasket receivers; and
each of the plurality of upper gaskets bonding to each of the plurality of upper gasket receivers.
